(19) United States
(12) Patent Application Publication
(10) Pub. No.: US 2009/0091313 A1
(43) Pub. Date: Apr. 9, 2009

(54) Inductive position sensor with integrated led indicators

(76) Inventors: Dale E. Teeters, Flower Mound, TX (US); Robert H. Luetzow, Highland Village, TX (US)

Correspondence Address: KRIEG DEVAULT LLP, ONE INDIANA SQUARE, SUITE 2800, INDIANAPOLIS, IN, 46204-2079, US

(21) Appl. No.: 12/231,210

(22) Filed: Aug. 29, 2008

Related U.S. Application Data
(60) Provisional application No. 60/997,720, filed on Oct. 4, 2007.

(51) Int. Cl. G01B 7/14; B60Q 3/00

(52) U.S. Cl. 324/207.16; 340/456

(57) ABSTRACT

A system for use in association with a mechanical transmission, including a gear selector lever movable between a plurality of shift positions corresponding to respective transmission settings, an inductive position sensor that senses a shift position of the gear selector lever, and a visual indicator that provides a visual indication of the selected transmission setting. The position sensor includes inductive sensor elements electromagnetically coupled together and sensor circuitry integrated onto a circuit board which generates a sensor output signal corresponding to the shift position of the gear selector lever. The visual indicator includes an indicator panel having alphanumeric characters that designate respective transmission settings, a plurality of LEDs integrated onto the circuit board and positioned adjacent respective ones of the alphanumeric characters, and control circuitry that provides a control signal in response to the sensor output signal which illuminates or brightens an LED positioned adjacent a respective one of the alphanumeric characters corresponding to the selected transmission setting.

### CROSS REFERENCE TO RELATED APPLICATIONS

The present application claims the benefit of U.S. Provisional Application No. 60/997,720 filed on Oct. 4, 2007, the contents of which are hereby incorporated by reference in their entirety.

### FIELD OF THE INVENTION

The present invention relates generally to the field of position sensors, and more particularly relates to an inductive position sensor with integrated light emitting diode (LED) indicators.

### BACKGROUND

Automotive vehicles equipped with an automatic transmission include a selector lever or shifter that allows the driver of the vehicle to engage the transmission in one of a series of predetermined transmission settings, including park, reverse, neutral, and one or more drive settings. The drive setting may include normal drive, overdrive and low gear settings. A visual indication system is also provided for indicating the selected transmission setting. Such systems typically include alphanumerical characters (e.g., P, R, N, D, L, OD, 3, 2, etc.) which are arranged alongside the travel path of the gear shifter selector lever, and a position indicator located adjacent the alphanumerical signs or symbols to provide a visual indication of the selected transmission setting. One type of visual indicator commonly used in association with automatic transmissions includes a mechanical pointer that is fixed with respect to the selector lever, and which is variably positioned adjacent the alphanumerical signs or symbols corresponding to the selected transmission settings. Other types of visual indicators include a series of lights positioned adjacent the alphanumerical signs or symbols, wherein the light located adjacent the alphanumerical sign or symbol which corresponds to the selected transmission setting is illuminated. Additionally, various types of position sensors are sometimes used to provide an electronic signal that corresponds to the physical position of the gear shifter selector lever and/or the selected transmission setting. Such position sensors include, for example, limit switches, microswitches and proximity sensors. In the past, the visual indication and position sensing systems have been provided separately by way of individual system components. However, providing visual indication and position sensing capabilities via separates system components tends to increase manufacturing and assembly costs. Additionally, particular care must be taken to avoid electrical or mechanical interference between the visual indication system and the position sensing system.

Thus, there remains a need for an improved position sensing system for use in association with a mechanical transmission. The present invention satisfies this need and provides other benefits and advantages in a novel and unobvious manner.

### SUMMARY

The present invention generally relates to an inductive position sensor with integrated light emitting diode (LED) indicators, and more specifically relates to a position sensing and visual indication system for use in association with a mechanical transmission.

In one form of the present invention, the system includes a transmission gear shifter mechanism including a gear selector lever movable between a plurality of predetermined shift positions corresponding to respective transmission settings, an inductive position sensor configured to sense a relative shift position of the gear selector lever associated with a selected one of the transmission settings, and a visual indicator configured to provide a visually perceptible indication of the selected transmission setting.

In one embodiment, the inductive position sensor includes a first inductive sensor element mechanically coupled to the selector lever, a second inductive sensor element electromagnetically coupled to the first sensor element, and inductive position sensor circuitry associated integrated onto a primary circuit board, wherein movement of the gear selector lever correspondingly displaces the first sensor element relative to the second sensor element, and with the first and second sensor elements cooperating to generate a sensor output signal corresponding to a position of the first sensor element relative to the second sensor element which in turn corresponds to the shift position of the gear selector lever associated with the selected transmission setting.

In another embodiment, the visual indicator includes an indicator panel including alphanumeric characters positioned adjacent corresponding ones of the predetermined shift positions and which designate respective transmission settings, a plurality of light emitting diodes integrated onto the primary circuit board and positioned adjacent respective ones of the alphanumeric characters, and indicator control circuitry associated with the light emitting diodes which provides an indicator control signal in response to the sensor output signal, and wherein one of the light emitting diodes positioned adjacent a respective one of the alphanumeric characters corresponding to the selected transmission setting being illuminated or brightened in response to the indicator control signal.

In another form of the present invention, an inductive position sensor is provided which includes integrated light emitting diode (LED) indicators. In a further form of the present invention, an inductive position sensor is provided which is configured to sense the position of transmission gear selector lever, and to generate a sensor output signal that controls a visual indication system to provide a visually perceptible indication of the selected transmission setting. In one embodiment, the visual indication system includes LED indicators that are integrated onto the same circuit board that includes circuitry associated with the inductive position sensor. In a further form of the present invention, an inductive position sensor is provided which is configured to sense the position of transmission gear selector lever, and to generate a sensor output signal that controls actuation of the transmission. While the actual nature of the invention covered herein can only be determined with reference to the claims appended hereto, certain forms of the invention that are characteristic of the preferred embodiments disclosed herein are described briefly as follows.

It is one object of the present invention to provide an inductive position sensor with integrated LED indicators. Further objects, features, advantages, benefits, and aspects of the present invention will become apparent from the drawings and description contained herein.

### BRIEF DESCRIPTION OF THE DRAWINGS

FIG. 1 is a perspective view of one embodiment of an automatic transmission gear shifter mechanism according to one form of the present invention.

FIG. 2 is a schematic representation in plan view of one embodiment of a position sensing and visual indication system including an inductive position sensor with integrated LED indicators for use in association with the present invention.

FIG. 3 is a schematic representation in elevation of the inductive position sensor of FIG. 2.

FIG. 4 is a schematic representation in plan view of another embodiment of a position sensing and visual indication system including an inductive position sensor with integrated LED indicators for use in association with the present invention.

FIG. 5 is a schematic representation in plan view of the inductive position sensor shown in FIG. 2.

FIG. 6A is a schematic representation of a sense coil associated with the inductive position sensor of FIG. 5.

FIG. 6B is a schematic representation of a sine coil associated with the inductive position sensor of FIG. 5, as positioned within an inner region of the sense coil.

FIG. 6C is a schematic representation of a cosine coil associated with the inductive position sensor of FIG. 5, as positioned within an inner region of the sense coil.

FIG. 7 is a schematic illustration of electronic circuitry according to one embodiment of the present invention for use in association with the position sensing and visual indication system of FIGS. 1 and 2.

### DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is hereby intended, and that alterations and further modifications to the illustrated devices and/or further applications of the principles of the invention as illustrated herein are contemplated as would normally occur to one skilled in the art to which the invention relates.

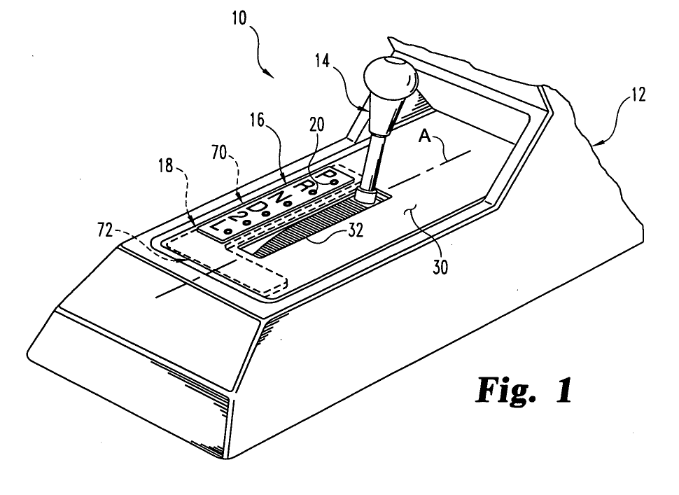

Referring to FIG. 1, shown therein is an automatic transmission gear shifter mechanism 10 according to one form of the present invention. The gear shifter mechanism 10 generally includes a console or housing 12, a gear selector lever 14, a visual indication system 16, a position sensing system 18 for sensing the position of the gear selector lever 14, and a series of light emitting diode (LED) indicators 20 associated with the visual indication system 16 for providing an indication of the sensed position of the gear selector lever 14 corresponding to the selected transmission setting. Although the present invention is illustrated and described for use in association with a transmission gear shifter mechanism, it should be understood that the present invention is also applicable to other applications requiring position sensing and visual indication capabilities, and is likewise not necessarily limited to the automotive field. It should also be understood that although the gear shifter mechanism 10 is illustrated and described for use in association with an automatic transmission, the present invention may also be used in association with other types of mechanical transmissions, including manual transmissions.

In the illustrated embodiment of the invention, the gear shifter mechanism 10 is particularly suited for mounting at a central location on the floor of an automobile in an area above the transmission. However, in other embodiments, the gear shifter mechanism 10 may be mounted to the steering wheel column or at other locations within the vehicle. The console 12 includes an interior region which houses the components and devices associated with the gear shifter mechanism 10, the details of which are generally known to those skilled in the art and need not be discussed in herein. The console 12 includes an upper panel 30 including a slotted opening 32 through which extends the shaft of the gear selector lever 14. In one embodiment, the selector lever 14 is coupled to the transmission via a mechanical linkage and is configured for axial displacement within the slotted opening 32, back and forth along an axis of travel A, to correspondingly change the setting of the transmission. The selector lever 14 is movable successively through a predetermined sequence of positions, including a parking position, a reverse position, a neutral position, and one or more forward speed positions. Although one embodiment of the invention contemplates mechanical coupling of the gear selector lever 14 to the transmission, in other embodiments, a drive-by-wire or shift-by-wire system may be utilized which does not require a mechanical linkage or coupling between the gear selector lever 14 and the transmission. In such systems, the position of the gear selector lever 14 may be sensed via the positioning sensing system 18 or another type of position sensing system, which in turn generates an electrical output signal that may be used to control an actuator or drive that operates to shift the transmission to the particular setting corresponding to the position of the gear selector lever 14. As should be appreciated, elimination of the mechanical linkage or coupling between the gear selector lever and the transmission and replacing such mechanical systems with an electronic position sensing system tends to reduce mechanical complexity and manufacturing and assembly costs.

In the illustrated embodiment of the invention, the visual indication system 16 is includes an indicator panel located alongside the travel path of the selector lever 14 (i.e., generally parallel with the axis of travel A) and includes alphanumerical characters that serve to designate corresponding ones of the settings or modes of the transmission. In the illustrated embodiment, the indicator panel includes the alphanumerical characters of P, R, N, D, 3, L, which correspond to the transmission settings of park, reverse, neutral, drive, third gear, and low gear. However, it should be understood that the indicator panel may include other orders and sequences of alphanumerical characters corresponding to the settings of other types and configurations of transmissions. It should also be understood that the alphanumerical characters need not necessarily include both letters and numbers, and may include signs or symbols. The visual indication system 16 also includes a series of indicator lights or LED indicators 20 positioned adjacent respective ones of the alphanumerical characters. As will be discussed in greater detail below, the position sensing system 18 is configured to sense the position of the gear selector lever 14 associated with a select transmission setting, and generates an electronic signal that illuminates or brightens the LED adjacent the alphanumerical character corresponding to the selected transmission setting to provide the driver with a visually perceptible indication of the selected transmission setting.

Although the illustrated embodiment of the visual indication system 16 includes six LED indicators 20, it should be understood that the visual indication system 16 may include any number of LED indicators. Additionally, although the illustrated embodiment of the visual indication system 16 shows the LED indicators 20 positioned laterally adjacent the alphanumerical characters, in other embodiments, the indicator panel associated with the visual indication system 16 may be formed of a transparent or translucent material, with the alphanumerical characters also being transparent or translucent. In such embodiments, the LED indicators 20 may be positioned beneath the alphanumerical characters such that illumination or brightening of a particular LED indicator 20 will illuminate or brighten the corresponding alphanumerical character. Such backlighting arrangements are well known to those of skill in the art and need not be discussed in further detail herein. Additionally, it should be understood that the LED indicators 20 may be of the same color (i.e., white) or may be provided in different colors (i.e., white, red, blue, yellow, etc.). Bi-color and/or multi-color RGB-type LED indicators may also be used. Furthermore, the LED indicators 20 may be turned on and off to indicate the selected transmission setting, or the brightness of the LED indicator 20 associated with the selected transmission setting may be increased to produce a higher luminous output or illumination intensity relative to the other LED indicators 20 to provide a visually perceptible indication of the selected transmission setting.

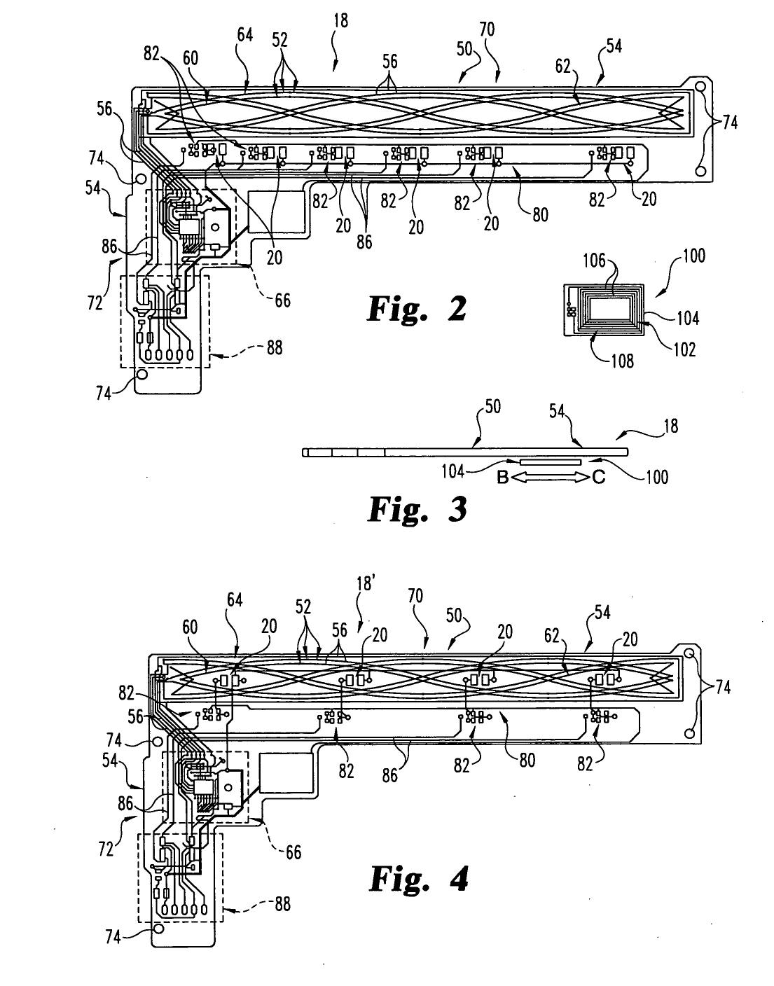

Referring to FIGS. 2 and 3, shown therein is a schematic representation of the position sensing system 18. In one form of the present invention, the position sensing system 18 is provided as an inductive-type position sensor generally comprised of a stationary sensor element or pad 50 including position sensor circuitry 52, and a movable sensor element or puck 100 including position sensor circuitry 102. In one embodiment, the stationary pad 50 and the movable puck 100 are each provided as a printed circuit board (PCB). However, other configurations are also contemplated. In a preferred embodiment of the invention, the pad 50 is mounted to the console 12 in a stationary position, and the puck 100 is mechanically coupled to the gear selector lever 14 such that movement of the selector lever 14 along the axis of travel A correspondingly displaces the puck 100 back and forth along the stationary pad 50 in the directions of arrows B and C.

In the illustrated embodiment of the invention, the stationary pad 50 is mounted in a horizontal orientation, with the surfaces of the stationary pad 50 including the position sensor circuitry 52 facing vertically. However, other embodiments are also contemplated wherein the stationary pad 50 may be mounted in a vertical orientation, with the surfaces of the stationary pad 50 including the position sensor circuitry 52 facing horizontally. Additionally, in the illustrated embodiment, the movable puck 100 is positioned below and displaced along a downwardly facing surface of the stationary pad 50. However, in another embodiment, the movable puck 100 may be positioned above and displaced along an upwardly facing surface of the stationary pad 50. Furthermore, in the illustrated embodiment, the position sensor 18 is configured such that the movable puck 100 is displaced in horizontal directions along the arrows B and C relative to the stationary pad 50. However, other embodiments are also contemplated wherein the position sensor 18 may be configured such that the movable puck 100 is displaced in vertical directions along arrows B and C relative to the stationary pad 50. Other mounting arrangements and orientations of the stationary pad 50 and the movable puck 100 are also contemplated as falling within the scope of the present invention.

In the illustrated embodiment of the invention, the position sensor 18 is configured as a linear position sensor wherein movement of the puck 100 relative to the pad 50 comprises linear movement. However, other embodiments are also contemplated wherein the position sensor 18 may be configured as a rotary position sensor such that movement of puck 100 relative to the pad 50 comprises rotational movement. Additionally, although the travel path of the puck 100 has been illustrated and described as being substantially linear, other travel paths are also contemplated, including arced or curved travel paths, curvilinear travel paths, or any other non-linear travel path that would occur to one of skill in the art. In the illustrated embodiment of the invention, the position sensor 18 is configured to sense movement of the puck 100 and the gear selector lever 14 along a single axis arranged generally parallel to the axis of travel A. However, in other embodiments, the position sensor 18 may be configured to sense movement of the puck 100 and the gear selector lever 14 along multiple axes, such as, for example, a first axis arranged generally parallel to the axis of travel A and a second axis arranged generally perpendicular to the axis of travel A (i.e., an x-axis and a y-axis). Such a configuration would be particularly suitable for use in association with a manual transmission wherein movement of the gear selector lever 14 occurs in multiple directions (i.e., forward-backward and side-to-side).

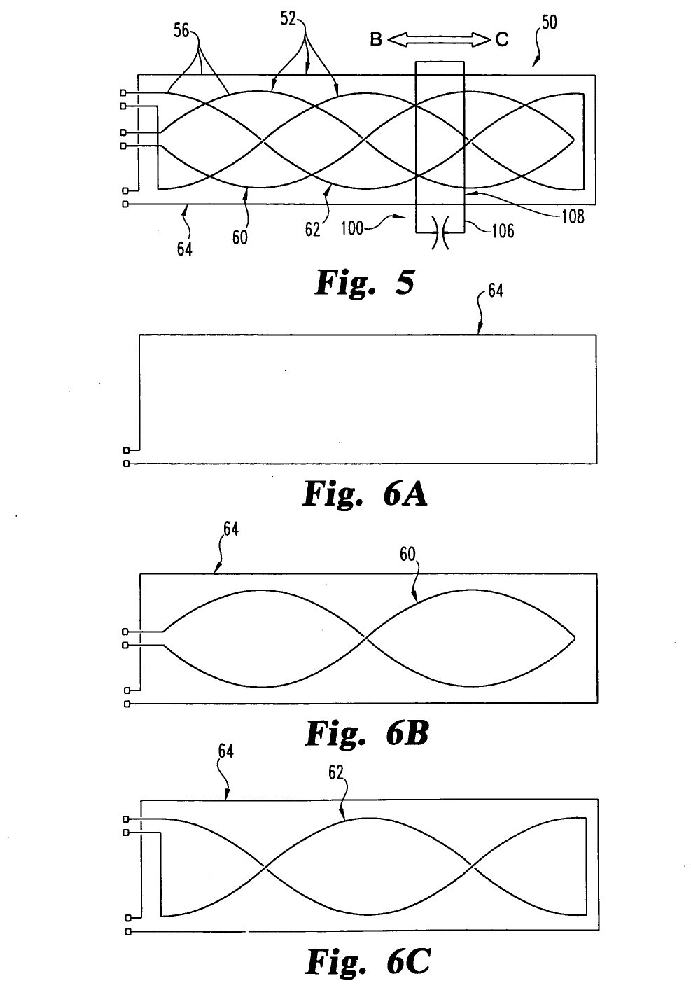

In the illustrated embodiment of the invention, the stationary pad 50 including the position sensor circuitry 52 comprises a circuit board 54 onto which is printed conductive tracks or traces 56 which are laid out to define coils or windings having particular shapes and configurations. Additionally, the movable puck 100 including the position sensor circuitry 102 comprises a circuit board 104 onto which is printed conductive tracks or traces 106 that are laid out to define a rectangular-shaped resonant coil or winding 108. As shown schematically in FIGS. 5 and 6A-6C, the tracks or traces 56 associated with the circuit board 54 are laid out to define a sine or transmit coil 60 and a cosine or transmit coil 62 which comprise excitation windings, and a sense or receive coil 64 which comprises a sensor winding. As shown in FIG. 6A, the sense coil 64 is configured as a loop having a rectangular shape. As shown in FIG. 6B, the sine coil 60 is located within the inner region of the sense coil 64 and is configured as a sine wave wherein a first half of the sine coil 60 is one-hundred and eighty electrical degrees out of phase relative to a second half. The sine coil 60 is positioned relative to the sense coil 64 at a “null point location” where electromagnetic signals transmitted from each half the sine coil 60 and received by the sense coil 64 are one-hundred and eighty degrees out of phase so as to cancel each other. Similarly, as shown in FIG. 6C, the cosine coil 62 is located within the inner region of the sense coil 64 and is configured as a cosine wave positioned relative to the sense coil 64 at a “null point location” wherein the electromagnetic signals transmitted from the cosine coil 62 and received by the sense coil 64 cancel one another out. Referring to FIG. 5, shown therein is the combined layout of the sine and cosine coils 60 and 62 within the inner region of the sense coil 64. Under normal operating conditions, the electromagnetic signals generated by the sine and cosine coils 60, 62 and received by the sense coil 64 are nulled or balanced out within the sense coil 64. As should be appreciated, if the electromagnetic signals within the sense coil 64 are not cancelled out and become unbalanced as a result of some physical phenomenon, such as the effects of other circuit traces or circuit components, proper functioning of the inductive position sensor 18 may be negatively affected.

In the illustrated embodiment, the circuit board 54 associated with the stationary pad 50 has an L-shaped configuration, including a generally rectangular-shaped elongate section 70 and a base section 72. The circuit board 54 may be provided with a number of mounting features 74 for mounting the circuit board to a substrate, such as, for example, to the upper panel 30 of the gear shifter console 12. The elongate section 70 of the circuit board 54 is generally aligned along the axis of travel A (FIG. 1) of the gear selector lever 14 and includes the traces 56 forming the inductive sensor coils 60, 62 and 64, and may also include the LED indicators 20 and portions of the LED indicator control circuitry. The base section 72 extends laterally from the elongate section 70 in a direction generally perpendicular to the axis of travel A and may include portions of the control circuitry associated with the position sensor 18 and the LED indicators 20. Although the illustrated embodiment of the circuit board 54 has an L-shaped configuration, other shapes and configurations of the circuit board 54 are also contemplated. Additionally, in the illustrated embodiment, the circuit board 104 associated with the movable puck 100 is provided with a rectangular configuration. However, other shapes and configurations of the circuit board 104 are also contemplated.

The circuit board 54 including the position sensor circuitry 52 also includes a position sensor control unit 66 which is preferably integrated onto the base section 72 of the circuit board 54. In one embodiment, the position sensor control unit 66 is provided as an application specific integrated circuit (ASIC) integrated onto the circuit board 54. However, other types and configurations of position sensor control circuits are also contemplated as would be apparent to one of ordinary skill in the art. One of the primary functions of the position sensor control unit 66 is to generate transmit signals which are provided to the sine and cosine coils 60 and 62. In one exemplary embodiment of the invention, the transmit signal provided to the sine coil 60 is a 4 MHz radio frequency signal that is 100 percent amplitude modulated by a 4 kHz square wave, and the transmit signal provided to the cosine coil 62 is a 4 MHz modulated square wave signal that is phase delayed relative to the sine square wave by ninety electrical degrees. The resonant coil 108 which may comprise a 4 MHz resonant circuit is positioned over the sine, cosine, and sensor coils 60, 62 and 64 and which is displaced back and forth along the coils as the sensor element 100 is displaced relative to the base element 50 in the directions of arrows B and C.

The resonant coil 108 is electromagnetically coupled to the sine and cosine coils 60 and 62, and electromagnetic energy generated by the sine and cosine coils 60 and 62 is transmitted to and received by the resonant coil 108. The resonant coil or winding 108 receives electromagnetic energy from both the sine and cosine coils 60 and 62, which in turn generates a circulating resonant current within the resonant coil 108. The resonant coil 108 is also electromagnetically coupled to the sense coil 64, and electromagnetic energy generated by the circulating current within the resonant coil 108 is transmitted to and received by the sense coil 64. An electronic signal is generated within the sense coil 64 which corresponds to the physical position of the resonant coil 108 relative to the sine, cosine and sense coils 60, 62 and 64, which in turn corresponds to the physical position of the movable puck 100 relative to the stationary pad 50. Since the movable puck 100 is fixedly coupled to the gear selector lever 14, the electrical signal generated within the sense coil 64 corresponds to the particular position of the gear selector lever 14, which in turn corresponds to the selected transmission setting. The electronic signal generated within the sense coil 64 (which corresponds to the position of the movable puck 100 relative to the stationary pad 50) is transmitted to the position sensor control unit 66. As will be discussed below, the position sensor control unit 66 in turn generates an output signal which is transmitted to the control circuitry associated with the visual indication system 16 to correspondingly control illumination of the LED indicators 20.

Further details regarding the inductive position sensor 18 are illustrated and described in U.S. Pat. No. 7,208,945 to Jones et al., the contents of which are incorporated herein by reference in their entirety. Specific details regarding the components associated with the inductive position sensor 18 and operation thereof are illustrated and described in the '945 patent, and therefore need not be specifically discussed herein. Although a particular configuration of the inductive position sensor 18 is illustrated and described herein, it should be understood that other types and configurations of inductive position sensors are also contemplated for use in association with the present invention.

As shown in FIG. 2, in the illustrated embodiment of the invention, the LED indicators 20 are integrated directly onto the same circuit board 54 which includes the position sensor circuitry 52 (i.e., the sine, cosine and sense coils 60, 62, 64 and the position sensor control unit 66). Additionally, control circuitry 80 associated with the LED indicators 20 is also integrated directly onto the circuit board 54. In the illustrated embodiment, the LED indicator control circuitry 80 includes a number of resistive elements 82 and high speed or fast switch diode elements 84 that are electrically connected to one another and to the LED indicators 20 via conductive tracks or traces 86 printed on the circuit board 54. Additionally, the LED control circuitry 80 includes an LED control unit 88 which is also integrated or mounted onto the circuit board 54. In one embodiment of the invention, the LED control unit 88 is provided as a PIC microcontroller chip. However, in other embodiments, the LED control unit 88 may be provided via other types and configurations of LED controllers or drive circuits. The LED indicator traces 86 may be printed on the same side of the circuit board 54 which includes the coil traces 56, or the indicator traces 86 may be printed on the side of the circuit board 54 opposite the coil traces 56. The LED indicators 20 and/or the indicator traces 86 are also preferably located on the side of the circuit board 54 opposite the coil traces 56 to minimize inductive loading of the circuitry associated with the LED indicators 20.

In one embodiment of the invention, the LED indicators 20 and the resistive elements 82 associated with the LED indictor control circuitry 80 are integrated onto the elongate section 70 of the circuit board 54 and are positioned adjacent the sine, cosine and sense coils 60, 62, 64 of the inductive position sensor 18. The diode elements 84 and the LED control unit 88 are preferably integrated onto the base section 72 of the circuit board 54 adjacent the position sensor control unit 66 at a location remote from the position sensor coils 60, 62, 64. In the illustrated embodiment, the LED indicators 20 and the resistive elements 82 are located outside of the inner region of the sense coil 64 which surrounds the sine and cosine coils 60, 62. However, as will be illustrated and described below, the LED indicators 20 may be positioned within the inner region of the sense coil 64. In still other embodiments, the resistive elements 82 may also be positioned within the inner region of the sense coil 64. Although the LED indicators 20 and the resistive elements 82 are illustrated and described as being integrated onto the elongate section 70 of the circuit board 54 adjacent the position sensor coils 60, 62, 64, it should be understood that in other embodiments, the LED indicators 20 and/or the resistive elements 82 may be positioned at other locations on the circuit board 54. Additionally, although the diode elements 84 and the LED control unit 88 are illustrated and described as being integrated onto the base section 72 of the circuit board 54, in other embodiments, the diode elements 84 and/or the LED control unit 88 may be positioned at other locations on the circuit board 54.

As should be appreciated, combining the LED indicators 20 and the LED indicator control circuitry 80 onto a common circuit board 54 which includes the position sensor circuitry 52 tends to decrease manufacturing and assembly costs. Additionally, it has been found that integration of the LED indicators 20 and the LED control circuitry 80 onto the circuit board 54 which includes the position sensor circuitry 52 does not degrade the functionality or accuracy of the inductive position sensor 18. More particularly, it has been found that positioning of the LED indicators 20 and the resistive elements 82 associated with the LED control circuitry 80 in close proximity with the inductive position sensor circuitry 52 (i.e., the sine, cosine and sensor coils 60, 62, 64) does not lead to disruption or unbalancing of the operating conditions associated with the inductive position sensor 18. Additionally, integration of the LED indicators 20 and the LED control circuitry 80 onto the common circuit board 54 does not generate noise or other undesirable signals within the inductive position sensor circuitry 52. Accordingly, the present invention provides the gear shifter mechanism 10 with the capability of sensing the position of the gear selector lever 14 and to provide a visual indication of the sensed position of the gear selector lever 14 which corresponds to the selected transmission setting. It should be appreciated that the position sensing and visual indication capabilities are provided in a cost effective manner while maintaining acceptable levels of accuracy and reliability.

Referring to FIG. 4, shown therein is a schematic representation of a position sensor 18′ according to another embodiment of the present invention. The position sensor 18′ is configured virtually identical to the position sensor 18 shown in FIG. 2. However, unlike the position sensor 18 which includes six LED indicators 20 integrated onto the circuit board 54, the position sensor 18′ includes four LED indicators 20 integrated onto the circuit board 54. As indicated above, the position sensors associated with the present invention may include any number of LED indicators 20, including two, three, five, or seven or more LED indicators integrated onto the circuit board 54. Additionally, unlike the position sensor 18 shown in FIG. 2 where the LED indicators 20 are positioned outside of the sense coil 64, the LED indicators 20 of the position sensor 18′ are positioned within the interior region of the sense coil 64, and more specifically within the areas or boundaries formed between the traces 56 associated with the sine and cosine coils 60 and 62. However, it should be understood that the LED indicators 20 may be positioned at other areas or locations within the sense coil 64, or at locations outside of the sense coil 64. Additionally, as indicated above, the resistive elements 82 associated with the LED control circuitry 80 may be located directly adjacent the sine, cosine and sense coils 60, 62, 64 of the position sensor 18. However, it should be understood that the resistive elements 82 may be positioned at other areas or locations of the circuit board 54.

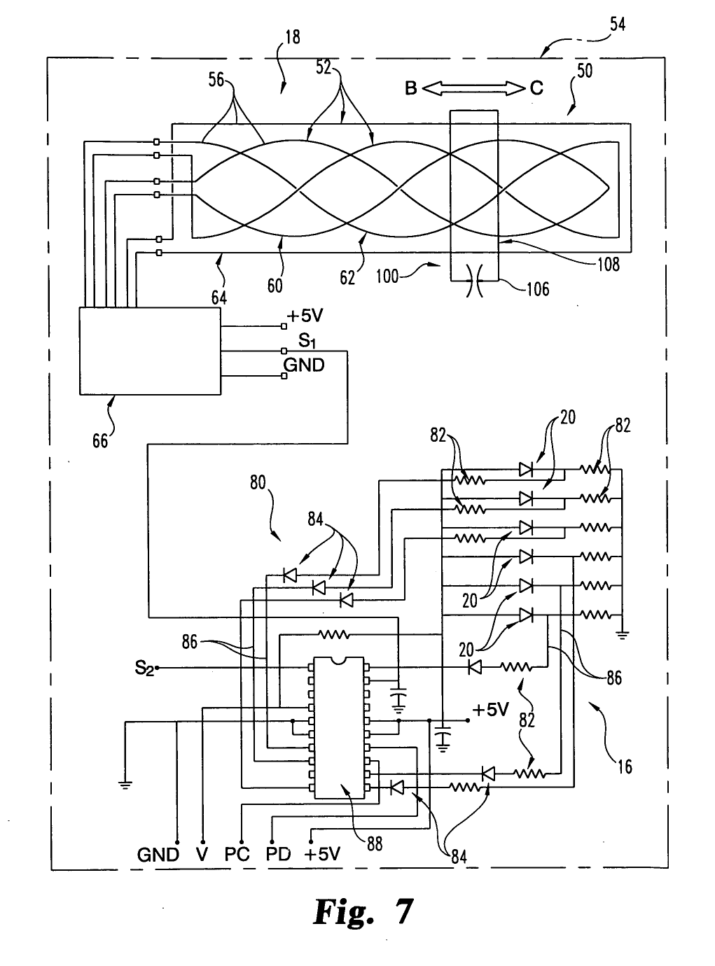

Referring to FIG. 7, shown therein is a schematic illustration of the electronic circuitry associated with the inductive position sensor 18, the integrated LED indicators 20, and the position sensor and LED control circuitry. As indicated above, the position sensor circuitry 52, the LED indicators 20, and the LED control circuitry 80 are integrated onto a common circuit board 54. It should be understood that the electronic circuitry illustrated in FIG. 7 is configured in accordance with conventional integrated circuit practice.

In the illustrated embodiment of the invention, the position sensor control unit 66 is provided with power/ground terminals and a signal output S₁ that is electrically connected to an input of the LED control unit 88. In one embodiment, the output signal generated by position sensor control unit 66 falls within a range of about 0.2 V to 4.8 V, with the output signal voltage corresponding to a particular position of the sensor puck 100 relative to the sensor pad 50, and more specifically the position of the sensor circuitry 102 relative to the sensor circuitry 52. However, it should be understood that the output signal generated by position sensor control unit 66 may fall within other voltage ranges. As indicated above, the position of the sensor puck 100 corresponds to the position of the gear shifter lever 14. Accordingly, the output signal generated by the position sensor control unit 66 corresponds to a particular position of the gear shift selector lever 14, which in turn corresponds to a selected transmission setting.

The LED control unit 88 is provided with power/ground terminals and a signal output S₂ which may be connected to a controller or computing device associated with another electronic system associated with the vehicle. In one embodiment, the signal output S₂ may be connected to a system configured to calibrate and/or test the visual indication system 16 and/or the position sensing system 18. In another embodiment, the signal output S₂ may be connected to another visual indication system, such as a dashboard indication system, to provide an input signal to control the operation of other lights or indicators. In other embodiments, the signal output S₂ may be connected to an engine or transmission control system or computer to provide an input signal corresponding to the selected transmission setting. The LED control unit 88 may also be provided with other inputs and outputs as would occur to one of ordinary skill in the art. The resistive elements 82 and the diode elements 84 are integrated into the LED control circuitry 80 per the schematic of FIG. 7 in accordance with conventional practice, the details of which would be understood by one of ordinary skill in the art and therefore need not be discussed herein. However, it should be understood that the LED control circuitry 80 is exemplary, and that other types and configurations of LED control circuits or drivers are also contemplated for use in association with the present invention.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

What is claimed is:

1. A position sensing and visual indication system for use in association with a mechanical transmission, comprising:
a transmission gear shifter mechanism including a gear selector lever movable between a plurality of predetermined shift positions corresponding to respective transmission settings;
an inductive position sensor configured to sense a relative shift position of said selector lever associated with a selected one of said transmission settings, said inductive position sensor comprising:
a first inductive sensor element mechanically coupled to said selector lever;
a second inductive sensor element electromagnetically coupled to said first sensor element; and
inductive position sensor circuitry integrated onto a primary circuit board, wherein movement of said selector lever between said plurality of predetermined shift positions correspondingly displaces said first sensor element relative to said second sensor element, and wherein said first and second sensor elements cooperate to generate a sensor output signal corresponding to a position of said first sensor element relative to said second sensor element which in turn corresponds to said shift position of said selector lever associated with said selected transmission setting; and
a visual indicator configured to provide a visually perceptible indication of said selected transmission setting, said visual indicator comprising:
an indicator panel including alphanumeric characters positioned adjacent corresponding ones of said predetermined shift positions of said selector lever, said alphanumeric characters designating said respective transmission settings;
a plurality of light emitting diodes positioned adjacent respective ones of said alphanumeric characters; and
indicator control circuitry associated with said light emitting diodes, said control circuitry providing an indicator control signal in response to said sensor output signal, wherein one of said light emitting diodes positioned adjacent a respective one of said alphanumeric characters corresponding to said selected transmission setting is illuminated or brightened in response to said indicator control signal.

2. The system of claim 1, wherein said plurality of light emitting diodes are positioned in close proximity to said inductive position sensor circuitry.

3. The system of claim 2, wherein said plurality of light emitting diodes are integrated directly onto said primary circuit board.

4. The system of claim 3, wherein one of said first and second sensor elements includes excitation and sensor circuitry, and wherein the other of said first and second sensor elements includes radio frequency resonator circuitry, said radio frequency resonator circuitry electromagnetically coupled to said excitation and sensor circuitry such that displacement of said first sensor element relative to said second sensor element results in displacement of said radio frequency resonator circuitry relative to said excitation and sensor circuitry which in turn generates said sensor output signal corresponding to said shift position of said selector lever associated with said selected transmission setting.

5. The system of claim 4, wherein said first sensor element that is mechanically coupled to said selector lever includes said radio frequency resonator circuitry.

6. The system of claim 4, wherein said excitation and sensor circuitry is integrated onto said primary circuit board, said light emitting diodes positioned proximately adjacent said excitation and sensor circuitry.

7. The system of claim 6, wherein said sensor circuitry includes an inductive sense coil extending peripherally about an inner sensor region with said excitation circuitry including at least one inductive transmit coil positioned within said inner sensor region, and wherein said light emitting diodes are positioned within said inner sensor region proximately adjacent said at least one inductive transmit coil.

8. The system of claim 3, wherein said inductive position sensor circuitry integrated onto said primary circuit board includes an inductive coil track extending peripherally about an inner sensor region; and
wherein said light emitting diodes are positioned within said inner sensor region defined by said inductive coil track.

9. The system of claim 8, wherein said inductive position sensor circuitry includes a sense coil defining said inner sensor region, said inductive position sensor circuitry further including a sine-shaped transmit coil and a cosine-shaped transmit coil positioned within said inner sensor region defined by said sense coil, said sine-shaped transmit coil and said cosine-shaped transmit coil overlapping one another to define boundaries surrounding a plurality of discrete areas within said inner sensor region; and
wherein said light emitting diodes are positioned within said discrete areas bound by said sine-shaped transmit coil and said cosine-shaped transmit coil.

10. The system of claim 1, wherein said inductive position sensor circuitry integrated onto said primary circuit board includes a plurality of inductive coil tracks extending along a first side of said primary circuit board; and
wherein said light emitting diodes are integrated directly onto a second side of said primary circuit board opposite said first side including said plurality of inductive coil tracks.

11. The system of claim 1, wherein said inductive position sensor circuitry integrated onto said primary circuit board includes a plurality of inductive coil tracks extending along a first side of said primary circuit board; and
wherein said indicator control circuitry includes LED indicator tracks electrically coupled to said light emitting diodes, said LED indicator tracks extending along a second side of said primary circuit board opposite said first side including said plurality of inductive coil tracks.

12. The system of claim 11, wherein said indicator control circuitry includes a plurality of resistive LED control elements; and
wherein said resistive LED control elements are mounted to said second side of said primary circuit board opposite said first side including said plurality of inductive coil tracks.

13. The system of claim 1, wherein said first sensor element that is mechanically coupled to said selector lever is displaceable along a first side of said primary circuit board; and
wherein said light emitting diodes are integrated onto a second side of said primary circuit board opposite said first side.

14. The system of claim 1, wherein said indicator control circuitry is integrated onto said primary circuit board.

15. The system of claim 14, wherein said indicator control circuitry includes a plurality of resistive LED control elements; and
wherein said plurality of light emitting diodes and said plurality of resistive LED control elements are integrated directly onto said primary circuit board and are positioned proximately adjacent said inductive position sensor circuitry on said primary circuit board.

16. The system of claim 1, wherein said primary circuit board has an L-shaped configuration including a base section and an elongate section extending generally perpendicular from said base section; and
wherein said inductive position sensor circuitry includes a sense coil extending peripherally about an inner sensor region and at least one transmit coil positioned within said inner sensor region, and wherein said sensor and transmit coils extend along said elongate section of said primary circuit board with said light emitting diodes integrated onto said elongate section of said primary circuit board adjacent said sensor and transmit coils; and
further comprising one or more electronic control units mounted to said base portion of said primary circuit board at a location more remote from said sensor and transmit coils than said light emitting diodes.

17. The system of claim 1, further comprising:
a position sensor control unit electrically coupled to said inductive position sensor circuitry; and
an LED control unit electrically coupled to said indicator control circuitry; and
wherein said position sensor control unit and said LED control unit cooperate to provide said indicator control signal to said one of said light emitting diodes.

18. The system of claim 1, wherein a first of said light emitting diodes emits a first color of light, and wherein a second of said light emitting diodes emits a second color of light different from said first color of light.

19. The system of claim 1, wherein at least one of said light emitting diodes selectively emits at least two different colors of light.

20. The system of claim 1, wherein said inductive position sensor comprises a uni-axial position sensor with said gear selector lever movable along a single axis of travel between said plurality of predetermined shift positions corresponding to said respective transmission settings.

21. The system of claim 1, wherein said inductive position sensor comprises a multi-axial position sensor with said gear selector lever movable along at least two axes of travel between said plurality of predetermined shift positions corresponding to said respective transmission settings.

22. A position sensing and visual indication system for use in association with a mechanical transmission, comprising:
a transmission gear shifter mechanism including a gear selector lever movable between a plurality of predetermined shift positions corresponding to respective transmission settings;
an inductive position sensor configured to sense a relative shift position of said selector lever associated with a selected one of said transmission settings, said inductive position sensor comprising:
a movable inductive sensor element including radio frequency resonator circuitry, said movable inductive sensor element mechanically coupled to said selector lever; and
a stationary inductive sensor element including excitation and sensor circuitry integrated onto a primary circuit board, said excitation and sensor circuitry electromagnetically coupled to said radio frequency resonator circuitry; and
wherein movement of said selector lever correspondingly displaces said movable sensor element relative to said stationary sensor element, and wherein said excitation and sensor circuitry and said radio frequency resonator circuitry cooperate to generate a sensor output signal corresponding to a position of said movable sensor element relative to said stationary sensor element which in turn corresponds to said shift position of said selector lever associated with said selected transmission setting; and
a visual indicator configured to provide a visually perceptible indication of said selected transmission setting, said visual indicator comprising:
an indicator panel including alphanumeric characters positioned adjacent corresponding ones of said predetermined shift positions, said alphanumeric characters designating said respective transmission settings;
a plurality of light emitting diodes positioned adjacent respective ones of said alphanumeric characters; and
indicator control circuitry associated with said light emitting diodes, said control circuitry generating an indicator control signal in response to said sensor output signal, wherein one of said light emitting diodes positioned adjacent a respective one of said alphanumeric characters corresponding to said selected transmission setting is illuminated or brightened in response to said indicator control signal.

23. The system of claim 22, wherein said plurality of light emitting diodes are positioned in close proximity to said excitation and sensor circuitry.

24. The system of claim 23, wherein said plurality of light emitting diodes are integrated directly onto said primary circuit board.

25. The system of claim 22, wherein said sensor circuitry includes an inductive sense coil extending peripherally about an inner sensor region with said excitation circuitry including at least one inductive transmit coil positioned within said inner sensor region, and wherein said light emitting diodes are positioned within said inner sensor region proximately adjacent said at least one inductive transmit coil.

26. The system of claim 22, wherein said at least one inductive transmit coil includes a sine-shaped transmit coil and a cosine-shaped transmit coil positioned within said inner sensor region defined by said sense coil, said sine-shaped transmit coil and said cosine-shaped transmit coil overlapping one another to define boundaries surrounding a plurality of discrete areas within said inner sensor region; and
wherein said light emitting diodes are positioned within said discrete areas bound by said sine-shaped transmit coil and said cosine-shaped transmit coil.

27. The system of claim 22, wherein said excitation and sensor circuitry integrated onto said primary circuit board includes a plurality of inductive coil tracks extending along a first side of said primary circuit board; and
wherein said light emitting diodes are integrated onto a second side of said primary circuit board opposite said first side including said plurality of inductive coil tracks.

28. The system of claim 22, wherein said excitation and sensor circuitry integrated onto said primary circuit board includes a plurality of inductive coil tracks extending along a first side of said primary circuit board; and
wherein said indicator control circuitry includes LED indicator tracks electrically coupled to said light emitting diodes, said LED indicator tracks extending along a second side of said primary circuit board opposite said first side including said plurality of inductive coil tracks.
